(19) United States
(12) Patent Application Publication
(10) Pub. No.: US 2006/0251891 A1
(43) Pub. Date: Nov. 9, 2006

(54) Label to be washed off

(75) Inventor: Eeva Aarnio, Tampere (FI)

Correspondence Address: VENABLE LLP, P.O. BOX 34385, WASHINGTON, DC, 20045-9998, US

(73) Assignee: Raflatac Oy, Tampere (FI)

(21) Appl. No.: 11/404,769

(22) Filed: Apr. 17, 2006

(30) Foreign Application Priority Data
Apr. 15, 2005 (FI) 20055177

(51) Int. Cl. B32B 7/12

(52) U.S. Cl. 428/343

(57) ABSTRACT

The present invention relates to an adhesive label comprising a label made of a plastic material, and an adhesive. The material of the label is a plastic film whose permeability to water vapour is greater than or equal to 10 g/m²×d, when the absolute value of its dimensional change is less than 1%; the permeability to water vapour is greater than or equal to 8 g/m²×d, when the absolute value of its dimensional change is 1 to 9%; or the permeability to water vapour is greater than or equal to 2 g/m²×d, when the absolute value of its dimensional change is greater than 9%.

### Cross-reference to related applications

This application claims priority to Finnish patent application 20055177 filed 15 Apr. 2005.

### FIELD OF THE INVENTION

The present invention relates to an adhesive label comprising a label made of a plastic material, and an adhesive.

### BACKGROUND OF THE INVENTION

Publication WO 00/62273 discloses an adhesive label that can be washed off, comprising a stretched film layer that shrinks in warm washing water, detaching the adhesive label.

Publication JP 09-114382 discloses an adhesive label that can be washed off, comprising a porous film layer that is permeable to water, and an adhesive layer. The adhesive layer contains a surfactant that reduces the strength of the adhesive when it comes into contact with water.

A common problem with the adhesive labels of prior art is that the adhesive must fulfill special requirements so that the label can be washed off.

### SUMMARY OF THE INVENTION

The adhesive label according to the invention is characterized in that the material of the label is a plastic film having
a permeability to water vapour greater than or equal to 10 g/m²×d, when the absolute value of its dimensional change is less than 1%,
a permeability to water vapour greater than or equal to 8 g/m²×d, when the absolute value of its dimensional change is 1 to 9%, or
a permeability to water vapour greater than or equal to 2 g/m²×d, when the absolute value of its dimensional change is greater than 9%.

The standards used for measuring the permeability to water vapour and the change in the dimensions are ISO 2528 and D-2732-03, respectively. The absolute value of the change in the dimensions refers to either an expansion or a shrinkage.

### DETAILED DESCRIPTION OF EMBODIMENTS OF THE INVENTION

A particular advantage of the adhesive label according to the invention is that the type of the adhesive can be chosen relatively freely. Normally, the adhesive used in objects intended to be washed off is a special glue that is easily washed off. In the case of the adhesive label according to the invention, it is also possible to use an adhesive that is intended to be permanent (a permanent glue), because the wash-off result is almost as good as when removable glues are used.

The adhesive label according to the invention is used in bottles of wine and soft drink industry; a particular use is wine bottles of glass, which can be provided with a distinguished label of a transparent plastic film. Thus, only the printing of the label stands out substantially from the surface of the bottle. Another feasible use is in plastic PET bottles. Furthermore, another possible use is in recyclable plastic boxes, from whose surface the adhesive label is to be removed in connection with washing.

The adhesive label according to the invention is washed off on a normal industrial washing line using an alkaline detergent and hot water. The washing temperature used is normally 60 to 90° C., and the washing water is alkaline. In some of the washing tests that were carried out to test the invention, water at 70° C. was used without an alkaline addition.

The adhesive label consists of a plastic film and an adhesive. The capability of being washed off is adjusted by two properties of the plastic film: its permeability to water vapour and its susceptibility to dimensional changes under certain conditions. Thus, if the absolute value of the dimensional change in the plastic film (shrinkage or expansion) is sufficiently high, the permeability to water vapour may be relatively small and the desired removability is still achieved. On the other hand, if the plastic film is dimensionally stable, the permeability to water vapour must be considerably higher than in the former case. Normally, for a plastic film used according to the invention, the permeability to water vapour is less than 100 g/m² per day (100 g/m²×d).

The wash-off result is excellent, if
the permeability to water vapour is greater than or equal to 10 g/m²×d, when the absolute value of its dimensional change is less than 1%,
the permeability to water vapour is greater than or equal to 9 g/m²×d, when the absolute value of its dimensional change is 1 to 12%, or
the permeability to water vapour greater than or equal to 2.5 g/m²×d, when the absolute value of its dimensional change is greater than 12%.

Preferably, the plastic film is a polyamide film or a polylactide film. Of the polyamides, particularly polyamide 6 but also polyamide 11 and polyamide 12 can be used.

Advantageously, the plastic film has certain physical properties so that the label can be quickly removed in fast industrial washing processes. For the water to be absorbed into the film sufficiently quickly, the plastic film has preferably a thickness not greater than 150 μm. Normally, the thickness of the film varies from 30 to 80 μm; particularly useful are films with a thickness of 30 to 50 μm. In view of the capability to be washed off, films thinner than 30 μm are excellent, but problems may occur in their further processing, for example in the removal of the waste web and dispension of the labels. The plastic film is normally a single-layer film or a multi-layer film made by coextrusion.

An advantageous example on the plastic material for use in the label is a polylactide film whose thickness is between 25 μm and 55 μm, preferably between 35 μm and 45 μm; grammage is between 30 g/m² and 70 g/m², preferably between 40 g/m² and 55 g/m²; water vapour permeability (ISO 2528) is between 20 g/m²×d and 60 g/m²×d, preferably between 30 g/m²×d and 50 g/m²×d; absolute value of its dimensional change (ISO 2732-03) is between 0.5% and 3.0%, preferably between 1.0% and 2.0%.

As mentioned above, any adhesive is suitable for use as the adhesive. Normally, the adhesives are based on an aqueous polymer dispersion which may contain a resin andlor auxiliary agents, such as a defoamer, an auxiliary agent for enhancing application, and a pH regulator. The content of the polymer and a possible resin is about 96 wt-%, and the content of each auxiliary agent may be 2 to 4 wt-%. The adhesive is normally based on an acrylate. Hot-melt adhesives suitable for use include UV hot melt type adhesives which are also typically acrylate-based.

Sometimes it happens that the plastic label has been removed from the bottle but the adhesive remains on the surface of the bottle. Therefore it is important that the adhesion of the adhesive is stronger to the plastic label material than to the bottle. In order to enhance the adhesion to the plastic material the surface of the plastic material (the surface which comes into contact with the adhesive) can be treated for example with plasma or corona. A lacquer or a primer can also be applied onto the surface of the plastic material. The label material can also be selected so that it is a co-extruded film having a higher surface energy on the first side of the plastic material (becoming into contact with the adhesive) than on the second side of the plastic material.

In the following, the invention will be described by means of examples.

Example 1

Adhesive labels according to the invention and control labels were attached to wine bottles of glass. The bottles were washed at a temperature of 70° C. in a 1.2 wt-% sodium hydroxide solution (NaOH solution) solely by spinning the bottles in the washing solution. In other words, no pressure was applied to boost the washing effect. The results of the washing tests are shown in Table 1.

The adhesive labels to be washed off were the following:

1. Polyamide film with a thickness of 40 μm and an adhesive intended to be washed off

2. The same as the adhesive label 1, but the surface of the label was compact printed (100%) with UV inks

3. Paper label and adhesive intended to be washed off

4. The same as the adhesive label 3, but the surface of the label was compact printed (100%) with UV inks

5. Polyamide film with a thickness of 40 μm and an adhesive intended to be permanent

6. Polyamide film with a thickness of 40 μm and a very adhesive glue intended to be permanent

7. Paper label and glue intended to be washed off (different glue and paper than in point 3)

8. Paper label and glue intended to be washed off (the same glue as in point 3)

For the 40 μm polyamide film (PA 6) used in the tests (test materials 1, 2, 5, 6), the permeability to water vapour was 12 g/m²×d and the absolute value of the dimensional change was 0.4%.

TABLE 1
Results of the washing tests.

| | Sample | | | | | | | |
|---|---|---|---|---|---|---|---|---|
| | 1 | 2 | 3 | 4 | 5 | 6 | 7 | 8 |
| Washing | 84 | 118 | 19 | 37 | 94 | 83 | 45 | 22 |
| time (s) | | | | | | | | |

The results of Table 1 indicate that the polyamide film used in the tests is washed off under said washing conditions, irrespective whether the adhesive is intended to be washed off or to be permanent.

Example 2.

The adhesive labels of Example 1 were glued to PET bottles and washed under the same conditions and in the same way as described in Example 1. The results of the washing tests are shown in Table 2.

TABLE 2
Results of the washing tests.

Sample

| | 1 | 2 | 3 | 4 | 5 | 6 | 7 | 8 |
|---|---|---|---|---|---|---|---|---|
| Washing | 25 | 31 | 12 | 19 | 24 | 36 | 30 | 15 |
| time (s) | | | | | | | | |

The results of Table 2 indicate that the polyamide film used in the tests is washed off under said washing conditions, irrespective whether the adhesive is intended to be washed off or to be permanent.

For comparison, tests were made to wash off a polypropylene label glued with the same adhesives as the polyamide films. It was found that the polypropylene film cannot be washed off, even if the washing time was more than 4 min.

Example 3.

The adhesive labels to be washed off were the following:

9. Polyamide film with a thickness of 20 μm and an adhesive intended to be washed off

10. Polyamide film (PA6) with a thickness of 40 μm and an adhesive intended to be washed off

11. Polyamide film (PA6) with a thickness of 20, μm and an adhesive intended to be washed off

12. Polyamide film (PA6) with a thickness of 20, μm and an adhesive intended to be washed off

13. Polyester film with a thickness of 36 μm and an adhesive intended to be washed off

14. Polypropylene film with a thickness of 60 μm and an adhesive intended to be washed off

15. Polypropylene film with a thickness of 30 μm and an adhesive intended to be washed off

15. Polylactide film and an adhesive intended to be washed off

The size of the adhesive label was 40 mm×70 mm. The adhesive labels were attached to the surface of the bottle one day before the washing.

| | | | Time in which the label was | | | |
|---|---|---|---|---|---|---|
| | | | detached from the bottle (min) | | | |
| | | Permeability | Washing | | Washing | |
| | | to | solution 1.2% | | solution | |
| | Dimensional | water | NaOH 70° C. | | H₂O 70° C. | |
| | change | vapour | Glass | PET | Glass | PET |
| Sample | (%)*⁾ | (g/m² × d) | bottle | bottle | bottle | bottle |
| 9 | −0.7 | 9.2 | 3.23 | 2.02 | 1.50 | 0.50 |
| 10 | +0.4 | 12 | 0.56 | 0.24 | 0.56 | 0.34 |
| 11 | +1.1 | 12.8 | 0.50 | 0.14 | 0.50 | 0.10 |
| 12 | −12.5 | 2.5 | 0.07 | 0.02 | 0.03 | 0.03 |
| 13 | +0.1 | 2.9 | >4.00 | >4.00 | >4.00 | >4.00 |
| 14 | −0.1 | 0.24 | >4.00 | >4.00 | >4.00 | >4.00 |
| 15 | −0.1 | 0.44 | >3.50 | 2.54 | >4.00 | >4.00 |
| 16 | −1.3 | 42 | 0.18 | 0.21 | 0.08 | 0.29 |

*⁾shrinkage −, expansion +

The results show that the label can be washed off, when the absolute value of the dimensional change and the permeability to water vapour for the plastic film are on certain levels.

1. An adhesive label comprising a label made of a plastic material, and an adhesive, wherein the material of the label is a plastic film with
a permeability to water vapour greater than or equal to 10 g/m²×d, when the absolute value of its dimensional change is less than 1%,
a permeability to water vapour greater than or equal to 8 g/m²×d, when the absolute value of its dimensional change is 1 to 9%, or
a permeability to water vapour greater than or equal to 2 g/m²×d, when the absolute value of its dimensional change is greater than 9%.

2. The adhesive label according to claim 1, wherein the plastic film is a polyamide film.

3. The adhesive label according to claim 2, wherein the plastic film is a polyamide 6 film.

4. The adhesive label according to claim 1, wherein the plastic film is a polylactide film.

5. The adhesive label according to claim 4, wherein the water vapour permeability of the polylactide film is between 20 g/m²×d and 60 g/m²×d, and the absolute value of its dimensional change is between 0.5% and 3.0%.
